(19) United States
(12) Patent Application Publication
(10) Pub. No.: US 2011/0006172 A1
(43) Pub. Date: Jan. 13, 2011

(54) Animal Head Positioning Device

(76) Inventor: Timothy J. Sargent, Ada, MN (US)

Correspondence Address: NEUSTEL LAW OFFICES, LTD., 2534 SOUTH UNIVERSITY DRIVE, SUITE 4, FARGO, ND, 58103, US

(21) Appl. No.: 12/500,362

(22) Filed: Jul. 9, 2009

(51) Int. Cl. F16M 11/02

(52) U.S. Cl. 248/156

(57) ABSTRACT

An animal head positioning device for efficiently supporting the head of a big game animal for a photograph. The animal head positioning device generally includes an elongated shaft having an upper end and a lower end, wherein the lower end is for being driven within the ground and a cradle mounted to the upper end of the elongated shaft for supporting a head of a game animal in an upright position. The cradle may be comprised of a U-shaped structure or a V-shaped structure and has ball tips on outer ends. The elongated shaft generally has a ring-shaped flange for separating a first portion of the elongated shaft positioned above the ground surface from a second portion of the elongated shaft positioned below the ground surface.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a head support device and more specifically it relates to an animal head positioning device for efficiently supporting the head of a big game animal for a photograph.

2. Description of the Related Art

Any discussion of the related art throughout the specification should in no way be considered as an admission that such related art is widely known or forms part of common general knowledge in the field.

Big game animals, such as whitetail deer, moose, elk, caribou, bear, coyote, and various others have been hunted or trapped for years. Typically, after the big game animal is in possession, through being trapped, shot, etc., it is customary for the hunter to capture the moment and the appearance of the animal in a photograph. To position the head of the animal in a manner that is photographically pleasing, the hunter must often times prop the head upon a nearby object or hold the head in an upright manner while the photograph or video is being taken.

Because of the large size and weight of the big game animals this can often be difficult. It can also be difficult to find a nearby object, such as a stick, stump, or rock that is suitable for propping the head of the animal upon. This can result in an inadequate photograph that may not be suitable to the hunter's liking. Because of the inherent problems with the related art, there is a need for a new and improved animal head positioning device for efficiently supporting the head of a big game animal for a photograph.

### BRIEF SUMMARY OF THE INVENTION

A system for efficiently supporting the head of a big game animal for a photograph. The invention generally relates to a head support device which includes an elongated shaft having an upper end and a lower end, wherein the lower end is for being driven within the ground and a cradle mounted to the upper end of the elongated shaft for supporting a head of a game animal in an upright position. The cradle may be comprised of a U-shaped structure or a V-shaped structure and has ball tips on outer ends. The elongated shaft generally has a ring-shaped flange for separating a first portion of the elongated shaft positioned above the ground surface from a second portion of the elongated shaft positioned below the ground surface.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention in the U-shaped embodiment.

FIG. 2 is a front view of the present invention in use.

FIG. 3 is a side view of the present invention in use to illustrate the positioning of the present invention around the head of the animal.

FIG. 4 is a front view of the present invention.

FIG. 5 is a front cross-sectional view of the embodiment of the present invention shown in FIG. 4.

FIG. 6 is a front view of the present invention with the cradle in an alternate shaped embodiment.

### DETAILED DESCRIPTION OF THE INVENTION

### A. Overview

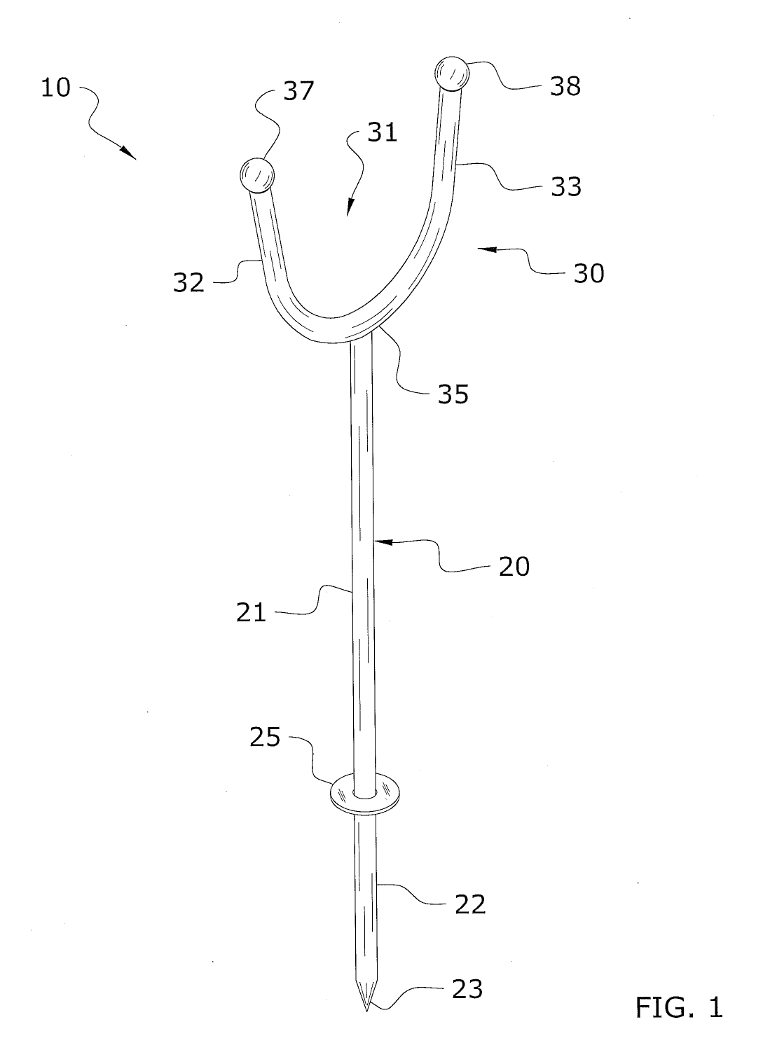

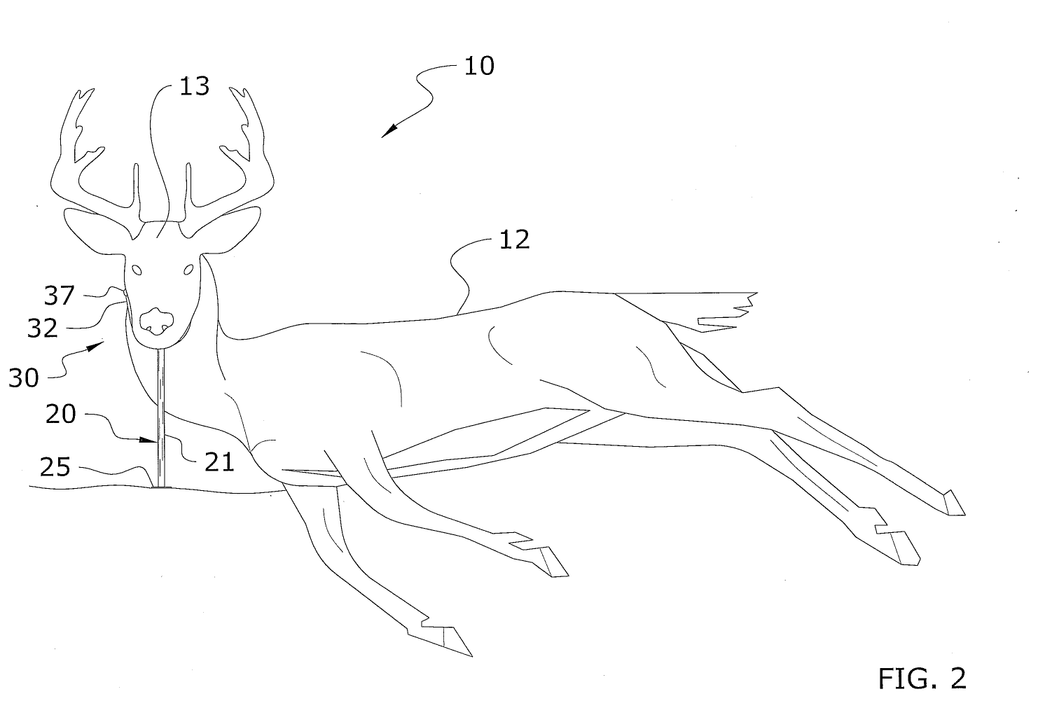

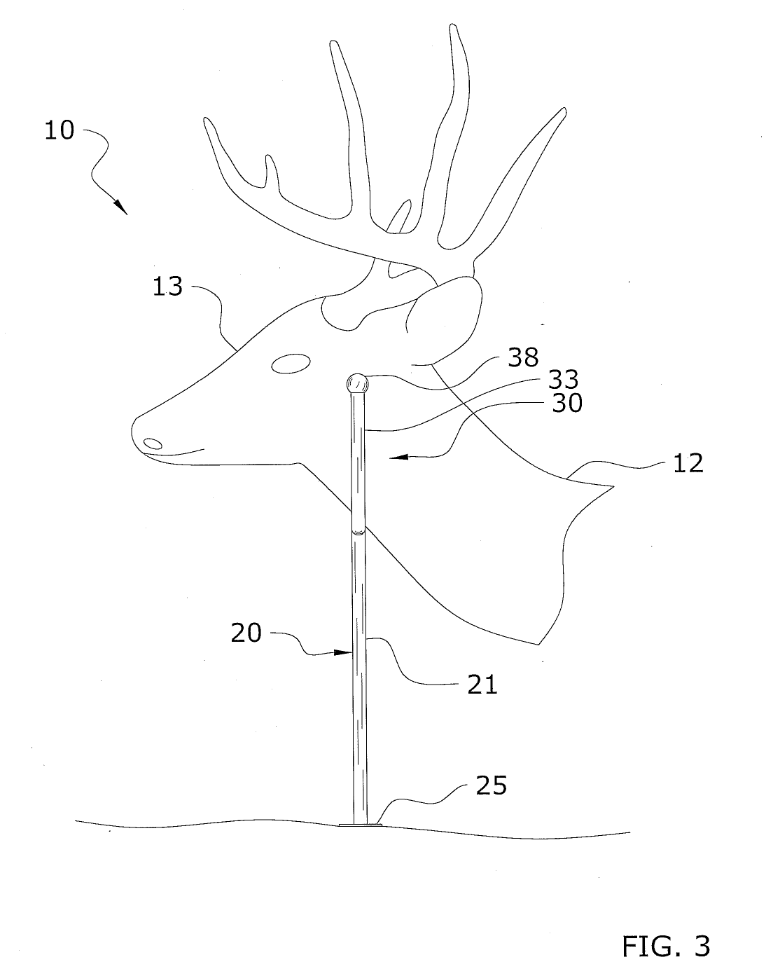

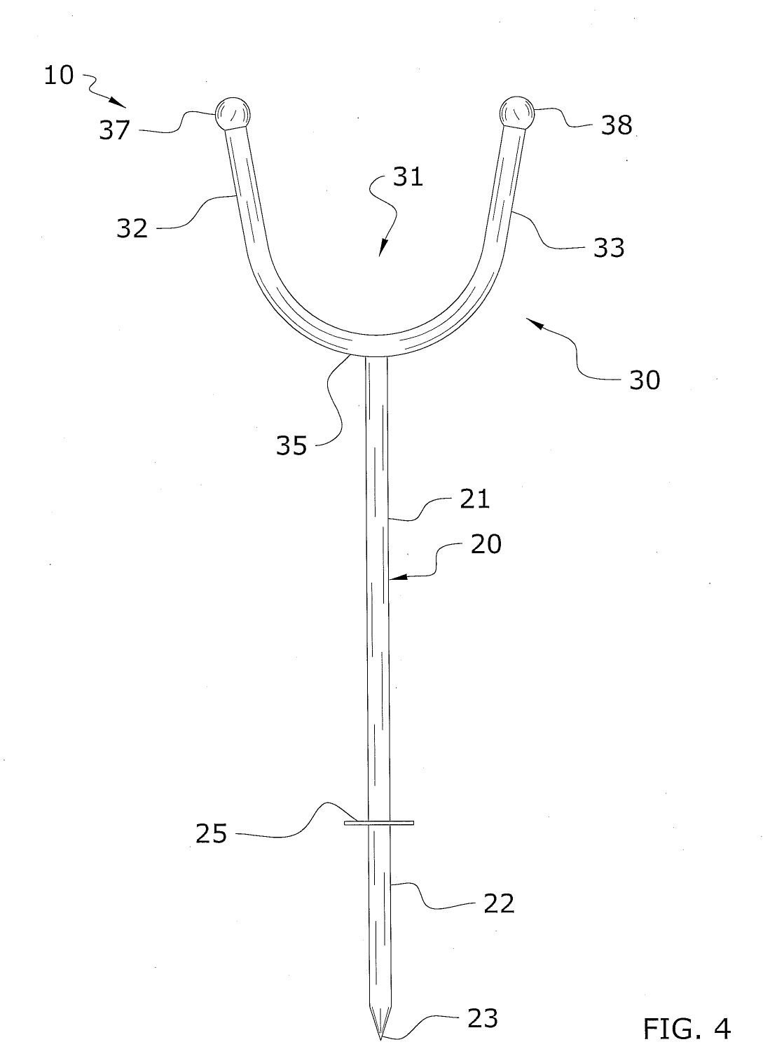

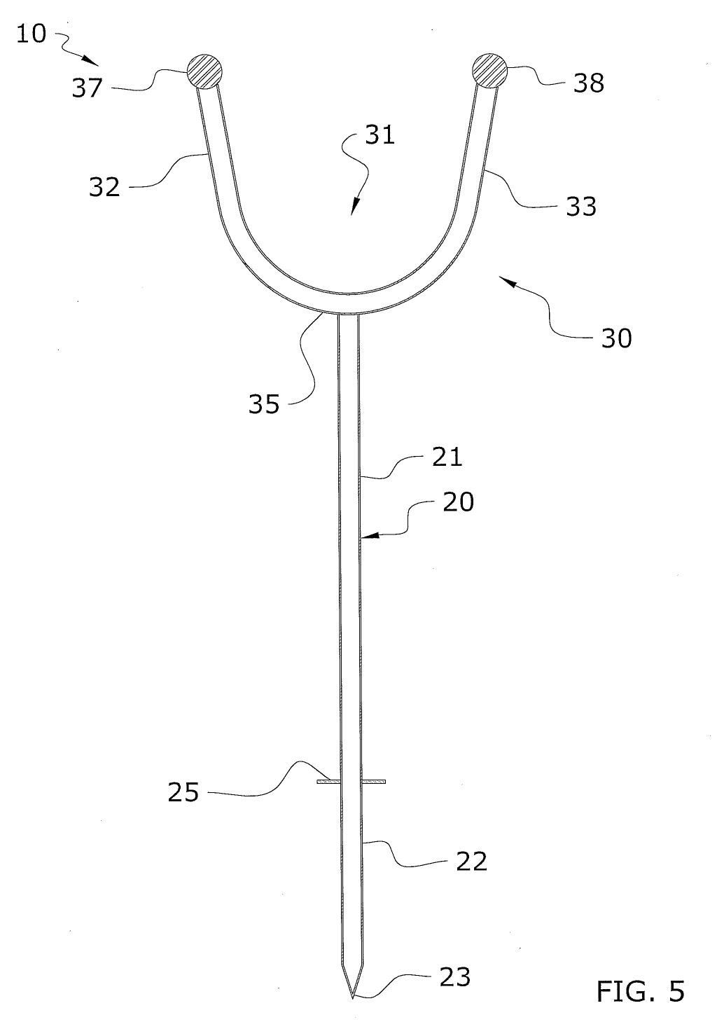

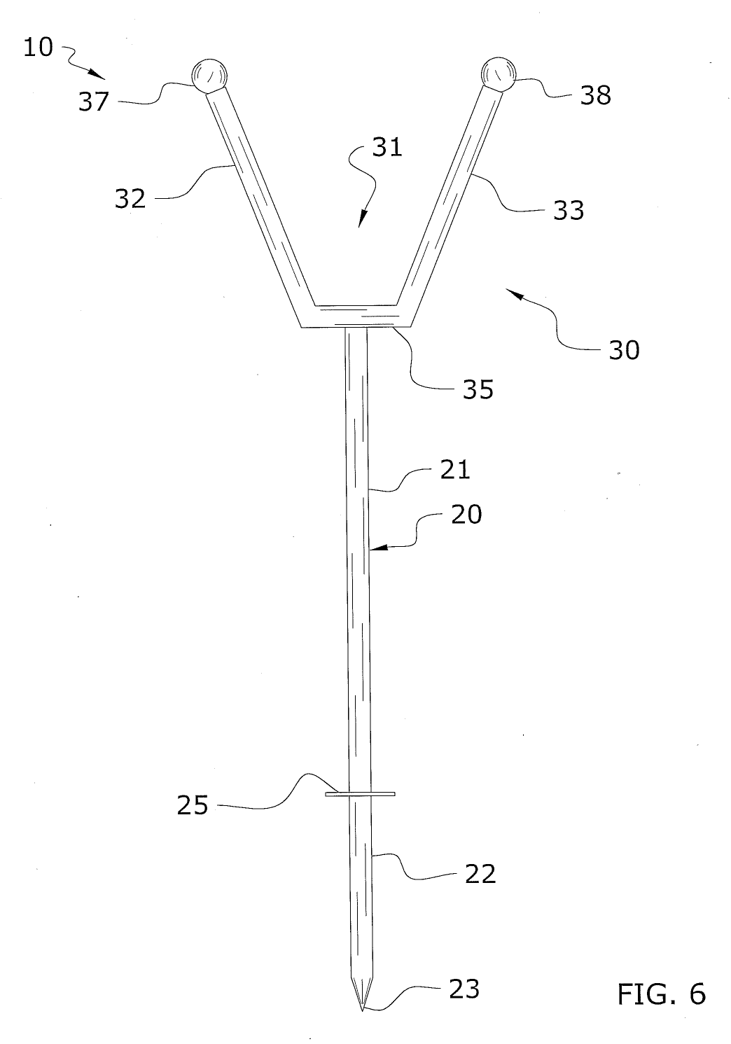

Turning now descriptively to the drawings, in which similar reference characters denote similar elements throughout the several views, FIGS. 1 through 6 illustrate an animal head positioning device 10, which comprises an elongated shaft 20 having an upper end and a lower end, wherein the lower end includes a pointed tip 23 and is for being driven within the ground and a cradle 30 mounted to the upper end of the elongated shaft 20 for supporting a head 13 of a game animal 12 in an upright position. The cradle 30 may be comprised of a U-shaped structure, a V-shaped structure, or various other shaped structures and has ball tips 37, 38 on outer ends. The elongated shaft 20 generally has a ring-shaped flange 25 for separating a first portion 21 of the elongated shaft 20 positioned above the ground surface from a second portion 22 of the elongated shaft 20 positioned below the ground surface. Further, the elongated shaft 20 and cradle 30 form a substantial Y-shaped structure.

The present invention may be used to support the head 13 of various types of animals 12 above the ground. The cradle 30 is generally sized to accommodate the neck or head 13 of big game animals 12; however the cradle 30 may be sized to accommodate the neck or head of various sized animals or creatures. Animals or big game animals may include, but is not limited to, whitetail deer, moose, elk, caribou, bear and coyote.

### B. Support Shaft

The support shaft 20 is used to support the cradle 30 above the ground surface which in turn supports the head 13 of the animal 12 above the ground surface. The support shaft 20 is generally comprised of an elongated and rigid structure capable of supporting a large amount of weight. The support shaft 20 may be comprised of various types of material, such as but not limited to metal including chrome moly tubing, plastic, or various other materials that provide a strong and rigid structure. The support shaft 20 is preferably hollow to provide a lightweight device 10; however it is appreciated that a solid support shaft 20 may be used in various alternate embodiments of the present invention. The support shaft 20 may further be circular in cross-sectional shape, square, or various other shapes.

The support shaft 20 is also preferably comprised of a uniform diameter structure. In the preferred embodiment, the support shaft 20 includes a first portion 21 that is generally positioned above ground and a second portion 22 that is generally stuck within the ground and positioned below the ground surface. The first portion 21 and the second portion 22 may be comprised of different lengths. The first portion 21 is comprised of a first length great enough to hold the head 13 of the big game animal 12 sufficiently above the ground surface. The second portion 22 is comprised of a second length great enough to extend within the ground a distance where the support shaft 20 remains stable and vertical while the head 13 or neck of the animal 12 is positioned within the cradle 30. The first portion 21 may also serve as a handle for the user to grasp and better steady the device 10 while in use.

The second portion 22, being able to be driven within the ground, preferably includes a tip 23 being comprised of a sharp, spiked, or pointed structure that will easily drive within the ground to make the support shaft 20 and device 10 a self-standing unit. It is appreciated that in alternate embodiments, the tip 23 may be comprised of various embodiments all of which allow the support shaft 20 to be steadied in a vertical orientation while the head 13 or neck of the animal 12 is positioned within the cradle 30.

The support shaft 20 also preferably includes a flange 25 projecting radially from the support shaft 20 around an entire perimeter of the support shaft 20 separating the first portion 21 and the second portion 22. The flange 25 is used to regulate the depth at which the support shaft 20 is driven within the ground by only allowing the user to insert the second portion 22 of the shaft 20 within the ground before the flange 25 engages the ground surface and restricts the user from pushing the support shaft 20 further within. The flange 25 is generally comprised of a ring shaped structure and is integrally formed or fixedly attached to the support shaft 20.

### C. Cradle

The cradle 30 is used to hold the head 13 above ground by cradling the head 13 of the animal 12. The cradle 30 may be used to cradle 30 various other parts of the animal 12, such as the shoulders, neck, etc. The cradle 30 is preferably comprised of a U-shaped structure; however a V-shaped structure may also be appreciated. The cradle 30 generally comprised of a similar material as the support shaft 20 and is fixedly attached to the upper end of the support shaft 20 (opposite the spiked tip 23) and is generally centered upon the support shaft 20. Like the support shaft 20, the cradle 30 may be tubular or solid in structure and may be comprised of various cross-sectional shapes.

The preferred U-shaped embodiment is shown in FIGS. 1-5. In the U-shaped embodiment of the cradle 30, the cradle 30 includes a first branch 32, a second branch 33, and a bottom portion 35 which collectively form a substantial U-shaped cavity 31 for receiving the animal 12. The first branch 32 and the second branch 33 mirror each other about the bottom portion 35, wherein the bottom portion 35 is affixed to the support shaft 20.

The first branch 32 and the second branch 33 also preferably each angle outwardly away from each other in a diagonal manner to form a generally tapering inwardly cavity 31 from either branch 32, 33 to help guide the head 13 of the animal 12 within the cavity 31 upon the bottom portion 35. The bottom portion 35 arcs downwardly to form the lower part of the U-shape. It is appreciated that the cradle 30 may be comprised of an integral structure or separate components affixed together. Each of the branches 32, 33 are also preferably straight in configuration and extend from each other in a linear maimer to form the substantially outwardly angling U-shaped structure and cavity 31. The upper end of the elongated shaft 20 and the bottom portion 35 also preferably directly connect near the longitudinal center of the bottom portion 35.

The alternate U-shaped embodiment is similar to the preferred except the bottom portion 35 is oriented horizontally in a straight manner to form a substantial T-shaped structure with the elongated shaft 20. In the alternate embodiment all of the branches 32, 33 and portions 35 of the cradle 30 are straight.

In either embodiment, the first branch 32 includes a first ball shaped tip 37 and the second branch 33 includes a second ball shaped tip 38 at a respective outer or upper end. The ball shaped tips 37, 38 are preferably comprised of identical structures and serve to guide the head 13 of the animal 12 smoothly within the cavity 31 by preventing the head 13 or other body part of the animal 12 from being caught on the end of the branches 32, 33. The ball shaped tips 37, 38 are generally comprised of a larger diameter than the branches 32, 33 to provide an increased surface area that is used for guiding the head 13 within the cavity 31.

### D. Operation of Preferred Embodiment

In use, the second portion 22 of the support shaft 20 is vertically driven within the ground via extending the spiked tip 23 within the ground and continuing to drive the support shaft 20 within the ground until engagement of the ground surface with the circular flange 25. The support shaft 20 may be rotated as desired so that the cradle 30 faces the camera or direction in which the head 13 of the animal 12 is to be directed.

The head 13 of the animal 12, adjacent the neck or the skull, is then positioned within the cavity 31 of the cradle 30 by guiding the head 13 past the ball shaped tips 37, 38 and upon the lower part (i.e. bottom portion 35 or connecting point 34) of the cradle 30 within the cavity 31. The branches 32, 33 and ball shaped tips 37, 38 work to keep the head 13 of the animal 12 propped in an upright orientation while positioned within the cavity 31 of the cradle 30 by engaging the sides of the head 13 via the tapered orientation of the branches 32, 33 to keep the head 13 propped upright. The bottom portion 35 also forms the resting point for the bottom of the head 13.

The animal 12 may now be photographed or displayed as desired. It is appreciated that in certain cases, the device 10 may need assisting to be kept in an upright manner, such as when supporting extremely heavy animals 12 or when stuck within soft ground that does not properly support the support shaft 20, such as within a swamp, sandy or wet area. To assist in maintaining the device 10 and head 13 of the animal 12 in an upright position, the first portion 21 of the support shaft 20 may simply be held while kneeling by the animal 12 when taking the photograph.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. An animal head support device, comprising:
an elongated shaft having an upper end and a lower end, wherein said lower end is for being driven within the ground; and
a cradle mounted to said upper end of said elongated shaft for supporting a head of a game animal in an upright position;
wherein said cradle includes a first branch, a second branch, and a bottom portion, wherein said first branch and said second branch extend from opposing ends of said bottom portion;
wherein said first branch and said second branch angle diagonally outwards;
wherein said first branch, said second branch, and said bottom portion form a substantially U-shaped structure.

2. The animal head support device of claim 1, wherein said first branch and said second branch are straight.

3. The animal head support device of claim 1, wherein said bottom portion is curved.

4. The animal head support device of claim 1, wherein said first branch, said second branch, and said bottom portion are straight.

5. The animal head support device of claim 4, wherein said elongated shaft and said bottom portion form a T-shaped structure.

6. The animal head support device of claim 1, wherein said first branch and said second branch are straight and wherein said bottom portion is curved.

7. The animal head support device of claim 1, wherein said cradle includes a first ball shaped tip positioned upon a first outer end of said first branch and a second ball shaped tip positioned upon a second outer end of said second branch.

8. The animal head support device of claim 7, wherein a diameter of said first ball shaped tip is greater than a diameter of said first branch and wherein a diameter of said second ball shaped tip is greater than a diameter of said second branch.

9. The animal head support device of claim 1, wherein said lower end of said elongated shaft includes a pointed tip.

10. The animal head support device of claim 1, wherein said elongated shaft includes a first portion for being positioned above a ground surface and a second portion for being positioned below said ground surface, wherein said elongated shaft includes a flange separating said first portion from said second portion.

11. The animal head support device of claim 11, wherein said flange is comprised of a ring shape to surround said elongated shaft.

12. An animal head support device, comprising:
an elongated shaft having an upper end and a lower end, wherein said lower end is for being driven within the ground; and
a cradle mounted to said upper end of said elongated shaft for supporting a head of a game animal in an upright position;
wherein said cradle includes a first branch, a second branch, and a bottom portion, wherein said first branch and said second branch extend from opposing ends of said bottom portion;
wherein said first branch and said second branch angle diagonally outwards;
wherein said first branch and said second branch are straight and wherein said bottom portion is curved.

13. The animal head support device of claim 12, wherein said cradle includes a first ball shaped tip positioned upon a first outer end of said first branch and a second ball shaped tip positioned upon a second outer end of said second branch.

14. The animal head support device of claim 13, wherein a diameter of said first ball shaped tip is greater than a diameter of said first branch and wherein a diameter of said second ball shaped tip is greater than a diameter of said second branch.

15. The animal head support device of claim 12, wherein said lower end of said elongated shaft includes a pointed tip.

16. The animal head support device of claim 12, wherein said elongated shaft includes a first portion for being positioned above a ground surface and a second portion for being positioned below said ground surface, wherein said elongated shaft includes a flange separating said first portion from said second portion.

17. The animal head support device of claim 16, wherein said flange is comprised of a ring shape to surround said elongated shaft.

18. The animal head support device of claim 17, wherein said first portion includes a pointed tip.

19. The animal head support device of claim 12, wherein said elongated shaft and said cradle form a Y-shaped structure.

20. An animal head support device, comprising:
an elongated shaft having an upper end and a lower end, wherein said lower end is for being driven within the ground;
wherein said lower end of said elongated shaft includes a pointed tip;
wherein said elongated shaft includes a first portion for being positioned above a ground surface and a second portion for being positioned below said ground surface;
wherein said elongated shaft includes a flange separating said first portion from said second portion;
wherein said flange is comprised of a ring shape to surround said elongated shaft; and
a cradle mounted to said upper end of said elongated shaft for supporting a head of a game animal in an upright position;
wherein said cradle includes a first branch, a second branch, and a bottom portion, wherein said first branch and said second branch extend from opposing ends of said bottom portion;
wherein said first branch and said second branch are oriented diagonally;
wherein said first branch, said second branch, and said bottom portion form a substantially U-shaped structure;
wherein said first branch and said second branch are straight;
wherein said first branch and said second branch are angled outwardly;
wherein said bottom portion is curved;
wherein said cradle includes a first ball shaped tip positioned upon a first outer end of said first branch and a second ball shaped tip positioned upon a second outer end of said second branch;
wherein a diameter of said first ball shaped tip is greater than a diameter of said first branch and wherein a diameter of said second ball shaped tip is greater than a diameter of said second branch.
